(19) United States
(12) Patent Application Publication
(10) Pub. No.: US 2007/0248313 A1
(43) Pub. Date: Oct. 25, 2007

(54) Archive Management Device, Archive Management System, and Archive Management Program

(75) Inventor: Mitsuhiro Kageyama, Kanagawa-ken (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/571,171

(22) PCT Filed: Jun. 20, 2005
(86) PCT No.: PCT/JP05/11231

§ 371 Date: Dec. 22, 2006

(30) Foreign Application Priority Data
Jun. 10, 2005 (JP) JP 2005-170512
Jun. 23, 2004 (JP) JP 2004-185409

(51) Int. Cl. H04N 5/93

(52) U.S. Cl. 386/55

(57) ABSTRACT

Application of a used image material can be checked without reading an edited image material stored in a database device when a program is produced. There is provided an archive management device including a database unit that holds an image material and image material metadata describing the contents of the image material, program structure table metadata that describes the contents of a program structure table, and edit metadata that describes the edited contents of the image material; and a simplified program replay metadata generation unit that executes, to a program structure table ID uniquely specifying the inputted program structure table, a generation process of simplified program replay metadata based on the image material metadata, the program structure table metadata, and the edit metadata held in the database unit and associated with the program structure table ID.

### BACKGROUND OF THE INVENTION

1. Technical Field of the Invention

The present invention relates to an archive management device, an archive management system, and an archive management program used by a television broadcasting station.

2. Description of the Related Art

In Japan, digital satellite broadcasting in 2000, ground-wave digital broadcasting in 2003, and digitized television broadcasting have been promoted so as to advance diversified broadcasting forms. With the digitized television broadcasting and diversified broadcasting forms, the equipment of a broadcasting station is being changed from analog program production to digital program production. The equipment of a broadcasting station has often edited an image material photographed on tape media by a linear editing device in the broadcasting station and transmitted a program using a cart machine for tape. In a digital operation form, it is assumed that a photographed image material is stacked onto an archive management device on which a random access medium such as an HDD is mounted, the image material is edited by on-line accessing the archive management device from a nonlinear editing device, and the completed program image material is transferred to a transmission device and transmitted. To respond to the new digital operation form, the necessity for an archive management device which can integrally manage digital data is expected to be increased. As a technique related to this, as described in Non-Patent Document 1, there has been proposed an archive management device which stacks plural image materials or program image materials, provides a search and viewing function of the image materials, and permits secondary utilization of the image materials.

Non-Patent Document 1: Gazette of the Japanese Society of Artificial Intelligence, vol. 18, No. 3 (May, 2003) , “Digital Archive” NHK Archives—from production to preservation—

A form using a prior art archive management device will be described below using the drawing. As shown in FIG. 1, a broadcasting station broadly divides program production into photographing groups performing photographing and editing groups editing a photographed image material and produces a program by centering an archive management device 1801. The photographing groups such as a news reporting group 1802, a sports group 1803, a variety show group 1804, and a drama group 1805 register a photographed image material into the archive management device 1801. Editing groups 1808 to 1810 editing the image material use nonlinear editing devices to on-line access the archive management device 1801 and edit the registered image material for producing the program. Use of the archive management device can easily produce the program.

The archive management device shared in the broadcasting station need to manage various image materials. Each of the editing groups editing the image material searches for and selects the necessary image material from the image materials managed by the archive management device to produce the program. For instance, the following Patent Document 1 describes association of an image material with a news manuscript and discloses an archive management device which displays the news manuscript together with the image material as a method of showing the searched result. The following Patent Document 2 discloses, as a method of showing a searched image material, an archive management device which shows a representative still image and audio of the image material.

Patent Document 1: Japanese Patent Application: No. Hei 9-18432

Patent Document 2: Japanese Patent Application: No. 2003-256432

### SUMMARY OF THE INVENTION

As image materials used for program production, there are a newly photographed image material and a previous image material used for a different program. A program producer desires to check application of the previous image material. When an image material searched for and referred using a keyword is used for a previous program, the program producer desires to check into which scene the image material is incorporated and which editing effect is provided to the same. The program producer refers to application of the used image material and can incorporate the previous image material into the newly produced program and can edit it in a manner different from the previously edited contents.

A database device stores an edited image material actually produced by combining or editing image materials used and commonly known as a complete package. Application of the used image material has been checked by reading the complete package from the database device. A newly photographed image material is managed by a different database device. The archive management device need to manage two database devices, that is, a database device storing the photographed image material and a database device storing the edited image material. When application of the used image material is checked to produce a program, the operation can be delayed in the archive management device.

In the program editing process, a person other than an editor can preview a program in process of being edited. In this case, the program image in process of being edited need to be received and replayed by streaming via a network from a location other than an editing room in which an editing device is installed, e.g., the desk of a producing room or the home of a director or producer, thereby checking the edited contents. The program image in process of being edited can be replayed and executed only by the editing application of the editing device performing the editing operation. The edited contents provided on the editing application, e.g., the image effect such as telop or fade-in and fade-out, and the mosaic process can be executed only on the editing application. To create an image given such edited contents for preview, the rendering process (so-called finalize of image editing or the generation process of a different substantial image by subjecting the original image to the imaging process) need to be performed on the editing application. The process time typically need to be the actual time of a completed image or time several times longer than that. A wait time which is the actual time of the image or longer is required from preview request to preview replay. To preview the image in process of being edited via a network, an expensive editing application need to be purchased and installed for each requiring device.

The present invention has noted such problems and an object of the present invention is to provide an archive management device which can check application of a used image material without reading a complete package stored in a database device when producing a program, cannot be delayed, and can preview replay a program image in process of being edited from a general-purpose image player as a different device without the editing application.

In the invention according to claim 1 of the present invention, an archive management device has a database unit that holds an image material and image material metadata describing the contents of the image material, program structure table metadata that describes a cut point and sequence of a material structuring a program, and edit metadata that describes the edited contents having an edit section and a special effects command of the image material; and a simplified program replay metadata generation unit that executes, to a program structure table ID uniquely specifying the inputted program structure table, a generation process of simplified program replay metadata based on the image material metadata, the program structure table metadata, and the edit metadata held in the database unit and associated with the program structure table ID.

In the invention according to claim 2 of the present invention, in the archive management device according to claim 1, the simplified program replay metadata generation unit has an image material replay timing generation unit describing image material replay timing, the image material replay timing generation unit including a program structure table metadata acquisition unit that acquires a program structure table ID uniquely specifying the program structure table and program structure table metadata associated with the program structure table ID; a cut extraction unit that extracts one cut from the cut loop of the program structure table metadata; an image material information extraction unit that extracts image material information from the extracted one cut; and an image replay command generation unit that generates an image replay command according to the information extracted by the image material information extraction unit.

In the invention according to claim 3 of the present invention, in the archive management device according to claim 1, the simplified program replay metadata generation unit has an edited contents display timing generation unit that describes edited contents display timing, the edited contents display timing generation unit including an edit metadata acquisition unit that acquires edit metadata associated with the program structure table ID, an edit metadata extraction unit that extracts the edit metadata for each item; an edited contents extraction unit that extracts edited contents from the edit metadata of the extracted one item; a command conversion unit that converts a special effects command included in the extracted edited contents to character string information; and an edited contents command generation unit that generates an edited contents display command for displaying the converted character string information in the same period as the edit section of the edited contents.

In the invention according to claim 4 of the present invention, in the archive management device according to claim 3, the simplified program replay metadata generation unit includes a character string conversion table associating the special effects command with a character string describing the special effects command, and the command conversion unit uses the character string conversion table to character string convert the special effects command.

In the archive management device according to claim 5 of the present invention, in the archive management device according to claim 3 or 4, the simplified program replay metadata generation unit includes a command building unit that builds the image replay command generated by the image material replay timing generation unit and the edited contents display command generated by the edited contents display timing generation unit; a sort unit that chronologically sorts the image replay command and the edited contents display command built by the command building unit; and a simplified program replay metadata output unit that outputs simplified program replay metadata having the sorted image replay command and edited contents display command.

In the invention according to claim 6 of the present invention, in the archive management device according to claim 1, the simplified program replay metadata generation unit registers the generated simplified program replay metadata into the database unit.

The invention according to claim 7 of the present invention, in the archive management device according to claim 1 further includes a simplified program replay metadata generation start unit that receives notification of registration completion of the image material metadata, notification of registration completion of the program structure table metadata, or notification of registration completion of the edit metadata to control the simplified program replay metadata generation unit, thereby controlling generation timing of the simplified program replay metadata.

In the invention according to claim 8 of the present invention, in the archive management device according to claim 1, the archive management device has an AV media streaming unit that transmits the streaming of the corresponding simplified program upon reception of a simplified program replay request.

In the invention according to claim 9 of the present invention, in the archive management device according to claim 1, the edit metadata is EDL metadata.

In the invention according to claim 10 of the present invention, in the archive management device according to claim 1, the program structure table metadata is EDL metadata.

In the invention according to claim 11 of the present invention, an archive management system includes the archive management device according to claim 1, and an image material search referring device that has a browser unit that requests image material search to the archive management device and requests simplified program replay metadata according to a result of the image material search, a multimedia player unit that requests simplified program replay according to the simplified program replay metadata received by the browser unit and replays a simplified program, and a timer unit that counts replay time of the simplified program.

In the invention according to claim 12 of the present invention, in the archive management system according to claim 11, the browser unit has a display unit that converts the result of the image material search to GUI, the display unit displaying, only for an image in which simplified program replay metadata is registered, an image material replay request button that requests replay of the image material and a simplified program replay request button that requests replay of the simplified program from the displayed image material searched result.

In the invention according to claim 13 of the present invention, in the archive management system according to claim 12, the display unit requests simplified program replay metadata corresponding to a position in which the simplified program replay request button is pressed.

In the invention according to claim 14 of the present invention, in the archive management system according to claim 11, the browser unit transfers the acquired simplified program replay metadata to the multimedia player unit.

In the invention according to claim 15 of the present invention, in the archive management system according to claim 11, the browser unit acquires image material information corresponding to the position in which the simplified program replay request button is pressed and transfers the acquired image material information to the multimedia player unit together with the simplified program replay metadata.

In the invention according to claim 16 of the present invention, in the archive management system according to claim 11, the multimedia player unit has a moving image replay frame that replays an image corresponding to the replay command according to the transferred simplified program replay metadata, and a character string display frame that displays character string information of the edited contents display command.

In the invention according to claim 17 of the present invention, in the archive management system according to claim 11, the multimedia player unit acquires count information of the timer unit, and changes with time the image of the simplified program replayed in the moving image replay frame and the edited contents of the simplified program displayed in the text display frame according to the count information.

In the invention according to claim 18 of the present invention, in the archive management system according to claim 16, the character string display frame has a mosaic effect display frame that displays a mosaic effect, a telop effect display frame that displays a telop effect, or an editing effect display frame that displays an editing effect described in the simplified program replay metadata.

In the invention according to claim 19 of the present invention, in the archive management system according to claim 11, the multimedia player unit acquires the image material information transferred together with the simplified program replay metadata from the browser unit and uses the image material information to request and replay the simplified program from an image replay command of the simplified program replay metadata or an image replay command immediately therebefore.

In the invention according to claim 20 of the present invention, an archive management program allows a computer to function as a database unit that holds an image material and image material metadata describing contents of the image material, program structure table metadata that describes a cut point and sequence of a material structuring a program, and edit metadata that describes the edited contents of the image material; and a simplified program replay metadata generation unit executing, to a program structure table ID uniquely specifying the inputted program structure table, a generation process of simplified program replay metadata based on the image material metadata, the program structure table metadata, and the edit metadata held in the database unit and associated with the program structure table ID.

According to the present invention, when a program is produced, the simplified program corresponding to the complete package is replayed without reading the complete package stored in the database device. Application of the used image material can be checked. When photographing gropes and editing groups use the archive management device at the same time, delay is less.

The foregoing objects and advantages of the present invention will be more apparent from the following embodiments described with reference to the accompanying drawings.

### BRIEF DESCRIPTION OF THE DRAWINGS

FIG. 1 is a diagram showing an archive management system using a prior art archive management device;

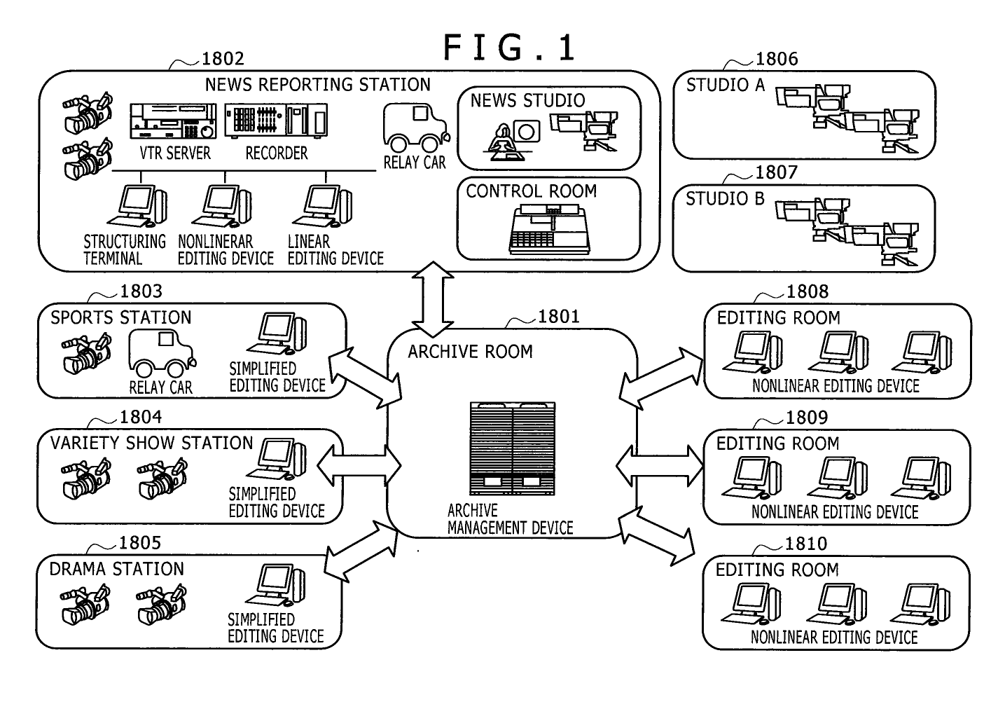

FIG. 2 is a block diagram showing the internal configuration of the archive management device and peripheral devices thereof according to Embodiment 1 of the present invention;

FIG. 3 is a block diagram showing the internal configuration of a simplified program replay metadata generation unit according to Embodiment 1;

FIG. 4 is a diagram showing a process of producing a program according to Embodiment 1;

FIG. 5 is a diagram showing the structure of image material metadata according to Embodiment 1;

FIG. 6 is a diagram showing a program structure table according to Embodiment 1;

FIG. 7 is a diagram showing the structure of program structure table metadata according to Embodiment 1;

FIG. 8 is a diagram showing the structure of edit metadata according to Embodiment 1;

FIG. 9 is a diagram showing the structure of edit metadata according to Embodiment 1;

FIG. 10 is a flowchart showing a process of generating a simplified program replay metadata generation unit according to Embodiment 1;

FIG. 11 is a diagram showing a character string conversion table according to Embodiment 1;

FIG. 12 is a diagram showing the structure of simplified program replay metadata according to Embodiment 1;

FIG. 13 is a diagram showing the relation between various metadata associated and held according to Embodiment 1;

FIG. 14 is a diagram showing a browser before performing image material search according to Embodiment 2 of the present invention;

FIG. 15 is a diagram showing a list of image material searched results according to Embodiment 2;

FIG. 16 is a diagram showing a browser obtaining the image material searched results according to Embodiment 2;

FIG. 17 is a diagram showing a multimedia player according to Embodiment 2; and

FIG. 18 is a sequence diagram showing the process between an image material search referring device and the archive management device according to Embodiment 2.

### DETAILED DESCRIPTION OF THE PREFERRED EMBODIMENTS

Best modes for carrying out the present invention will be described below using the drawings. In Embodiment 1, an archive management device will be described, and in Embodiment 2, an archive management system will be described. In Embodiment 1, there will be described the archive management device which generates simplified program replay metadata using various metadata registered into the archive management device and stores the simplified program replay metadata associated with the metadata. In Embodiment 2, there will be described the archive management system which searches for an image material stored in the archive management device using an image material search referring device and replays a simplified program from the result. The present invention is not limited to the following embodiments and can be suitably modified and embodied in the scope without deviating from the purport of the invention.

### Embodiment 1

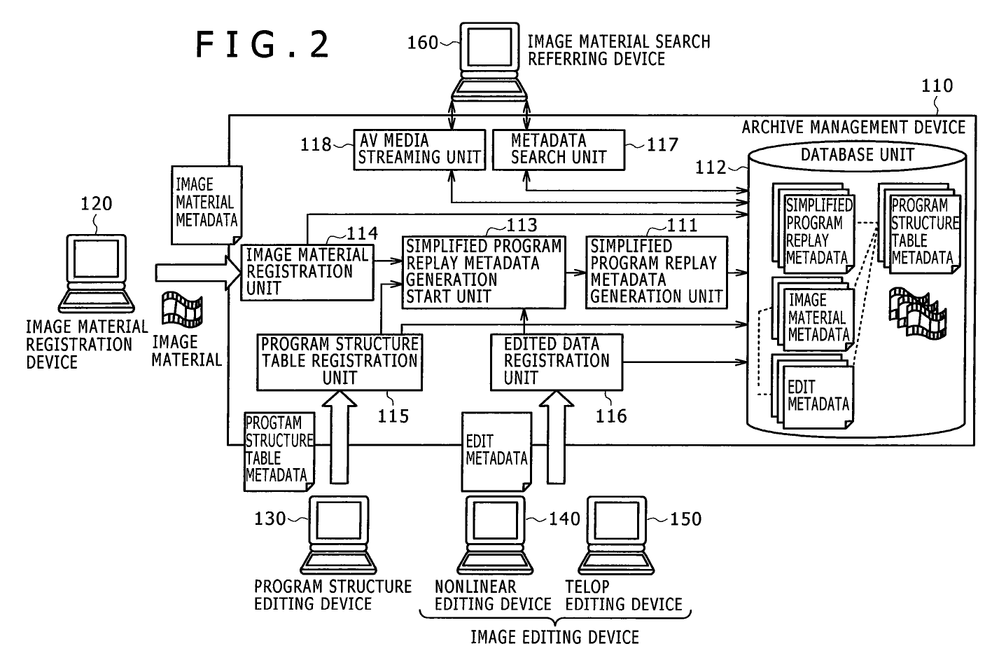

Embodiment 1 of the present invention will be described. FIG. 2 shows an archive management device and peripheral devices thereof. The peripheral devices of an archive management device 110 are an image material registration device 120, a program structure editing device 130, a nonlinear editing device 140, a telop editing device 150, and an image material search referring device 160. The archive management device 110 registers an image material and image material metadata from the image material registration device 120, program structure table metadata from the program structure editing device 130, and edit metadata from the nonlinear editing device 140 or the telop editing device 150. The image material and metadata are held in the database unit 112 in the archive management device 110. The archive management device 110 executes the generation process of simplified program replay metadata based on the image material metadata, the program structure table metadata, or the edit metadata to register the simplified program replay metadata into the database unit 112. The archive management device 110 receives a search request of the image material from the image material search referring device 160 for performing search and replays a simplified program when there is a replay request of the simplified program based on the result. The image material registration device 120 photographs an image and generates image material metadata describing the contents of the photographed image material. The image material and the image material metadata are registered into the archive management device 110. The program structure editing device 130 decides a program structure to create a program structure table and generates program structure table metadata describing the contents of the program structure table. The program structure table metadata is registered into the archive management device 110. The nonlinear editing device 140 edits the image material stored in the database unit 112 and performs cutting and combination of the image materials. The telop editing device 150 provides special effects such as a telop or editing effect to the edited image material. The nonlinear editing device 140 or the telop editing device 150 edits the image material and generates edit metadata describing the edited contents. The edit metadata is registered into the archive management device 110. The edit metadata generated in this embodiment is EDL (Edit Decision List) metadata. The image material search referring device 160 requests search for the image material to the archive management device 110, receives the response, requests replay of the image material or the simplified program based on the result, performs the streaming of the image material, and replays it.

The internal configuration of the archive management device 110 will be described. As shown in FIG. 2, the archive management device 110 has a simplified program replay metadata generation unit 111, the database unit 112, a simplified program replay metadata generation start unit 113, an image material registration unit 114, a program structure table registration unit 115, an edited data registration unit 116, a metadata search unit 117, and an AV media streaming unit 118. The simplified program replay metadata generation unit 111 executes the generation process of the simplified program replay metadata based on the image material metadata, the program structure table metadata, and the edit metadata and registers the generated simplified program replay metadata into the database unit 112. The internal configuration of the block will be described later in more detail. The database unit 112 holds the image material, the image material metadata, the program structure table metadata, the edit metadata, and the simplified program replay metadata. RAID (Redundant Arrays of Independent Disks) or a cart machine is used as the database unit 112. The simplified program replay metadata generation start unit 113 controls generation timing of the simplified program replay metadata generated by the simplified program replay metadata generation unit 111. The generation timing includes notification of registration completion of the image material metadata, notification of registration completion of the program structure table metadata, or notification of registration completion of the edit metadata and receives it to control generation timing of the simplified program replay metadata. The image material registration unit 114 receives the image material and the image material metadata registered from the image material registration device 120 and transmits these to the database unit 112 and the simplified program replay metadata generation start unit 113. The program structure table registration unit 115 receives the program structure table metadata registered from the program structure editing device 130 and transmits the same to the database unit 112 and the simplified program replay metadata generation start unit 113. The edited data registration unit 116 receives the edit metadata registered from the nonlinear editing device 140 or the telop editing device 150 and transmits the same to the database unit 112 and the simplified program replay metadata generation start unit 113. The metadata search unit 117 receives the search request of the image material from the image material search referring device 160 and searches for the corresponding metadata from the database unit 112. The AV media streaming unit 118 receives the request of replay of the image material and the simplified program from the image material search referring device 160 and transmits the streaming of the image material held in the database unit 112. The AV media streaming unit 118 receives the request of replay of the simplified program from the image material search referring device 160 and transmits the streaming of the corresponding image material to the simplified program replay metadata held in the database unit 112.

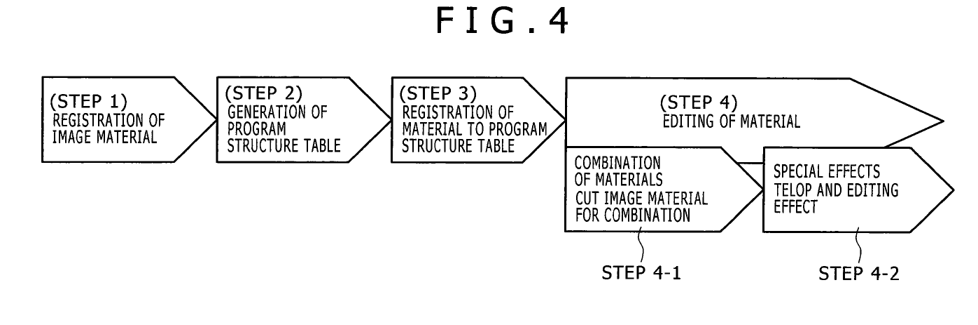

There will be described the procedure of registering an image material and various metadata generated by the image material registration device 120, the program structure editing device 130, the nonlinear editing device 140, and the telop editing device 150 into the archive management device 110. The image material and metadata are generated and registered according to the flow of program production. As shown in FIG. 4, the program production has steps 1 to 4.

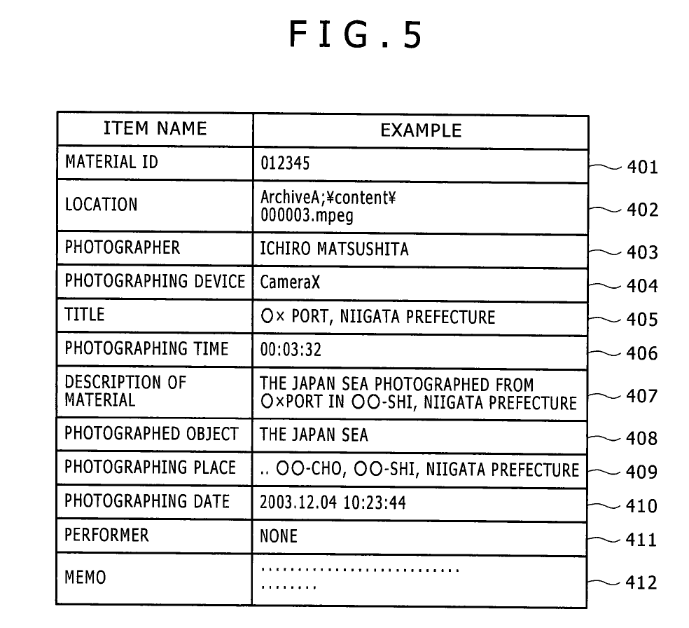

In step 1, an image photographed by the image material registration device 120 is registered. As described above, the image material registration device 120 photographs an image and generates image material metadata describing the contents of the image material. The image material metadata will be described. As shown in FIG. 5, the image material metadata has a material ID 401 uniquely specifying an image material, a location 402 showing the stored side of the image material, a photographer 403 photographing the image, a photographing device 404 showing photographing device information, a title 405 of the image material, photographing time 406 of the image material, description of the material 407 describing the contents of the image material by a character string, a photographed object 408, a photographing place 409, a photographing date 410, a performer 411 performing in the image, and a memo 412 in which the photographer or the program producer can freely describe the image material. The material ID 401 is automatically numbered and registered by the image material registration device 120 or the archive management device 110 when the image material is registered. In the location 402, the path to the database unit 112 is registered. The photographing device 404, the photographing time 406, and the photographing date 410 can be automatically registered by the image material registration device 120. Various pieces of information can be registered on the registration screen of the image material registration device 120 when the image material is registered. The image material metadata generated by the image material registration device 120 is inputted to the image material registration unit 114. The image material registration unit 114 registers the image material and the image material metadata into the database unit 112. The image material registration unit 114 inputs the image material metadata to the simplified program replay metadata generation start unit 113.

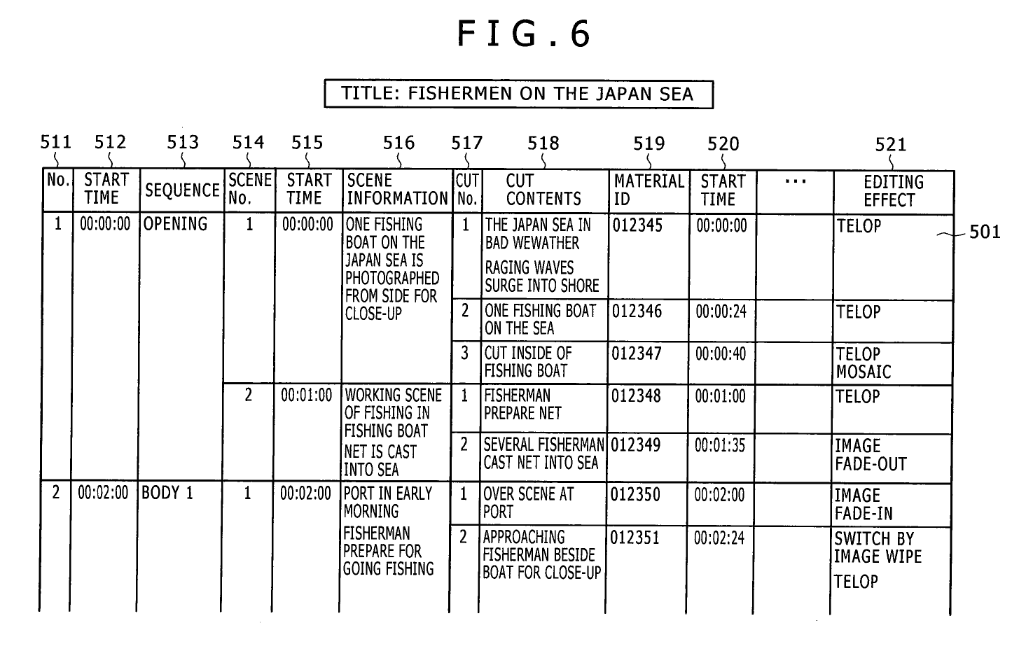

In step 2, the program structure editing device 130 creates a program structure table. As shown in FIG. 6, the program structure table hierarchically manages a sequence, scene, and cut and is created by allocating the contents of the image and time. In step 3, the contents of the image material and time are embedded into the program structure table from the image material metadata registered by the image material registration device 120. For instance, the reference numeral 501 indicates that cut contents 518=“The Japan Sea in bad weather; Raging waves surge into shore” belongs to scene information 516=“One fishing boat on the Japan Sea is photographed from side for close-up” and the scene belongs to a sequence 513=“opening”. The program structure table may be decided before or after the image material is registered. In this embodiment, after the image material is registered, the program structure table is created and the registered image material is embedded into the program structure table. After the program structure table is created, the image material may be photographed according to the program structure table and embedded. The program structure editing device 130 generates the program structure table metadata describing the contents of the program structure table according to the created program structure table.

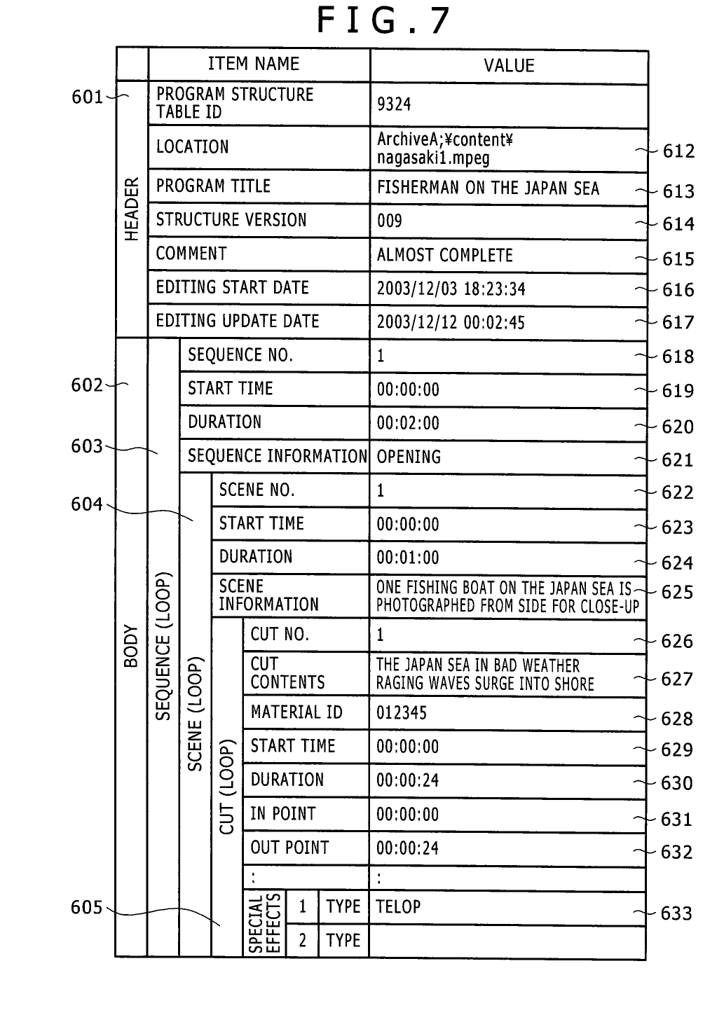

The program structure table metadata generated by the program structure editing device 130 will be described. As shown in FIG. 7, the program structure table metadata is divided into a header unit 601 and a body unit 602. The header unit 601 has a program structure table ID 611 uniquely specifying a program structure table, a location 612 showing the stored side of the program structure table, a program title 613, a structure version 614 showing the completion degree of the program structure table, a comment 615 in which the program producer can freely describe the program structure table, an editing start date 616 on which editing of the program structure table is started, and an editing update date 617 on which editing of the program structure table is updated. As in the material ID 401, the program structure table ID 611 is automatically numbered and registered by the program structure editing device 130 or the archive management device 110 when the program structure table metadata is registered. The structure version 614 shows the number in ascending order each time the program structure table is registered and updated. The editing start date 616 and the editing update date 617 are registered by the program structure editing device 130 or the archive management device 110. Various pieces of information such as the program title 613 and the comment 615 can be registered on the editing screen of the program structure editing device 130. The body unit 602 hierarchically manages a sequence 603, a scene 604, and a cut 605 in the program structure table and allocates the contents of the image and time. The sequence information has a sequence number 618 describing a sequence number, start time 619 showing start time count in the program of the sequence, duration 620 showing time length of the sequence, sequence information 621 as description information on the sequence, and all scene information belonging to the sequence. The sequence number 618, the start time 619, and the sequence information 621 correspond to a number 511, start time 512, and a sequence 513 of the program structure table. The scene information has a scene number 622 describing a scene number in the sequence, start time 623 showing start time count in the program of the scene, duration 624 showing the time length of the scene, scene information 625 as description information on the scene, and all cut information belonging to the scene. The scene number 622, the start time 623, and the scene information 625 correspond to a scene number 514, start time 515, and scene information 516 of the program structure table. The cut information has a cut number 626 describing a cut number in the scene, cut contents 627 as description information on the cut, a material ID 628 of the image material used for the cut, start time 629 showing start time count in the program of the cut, duration 630 showing the time length of the cut, an In point 631 showing actually used time count of the image material, an Out point 632 showing final count, and all special effects information 633 provided to the cut. The cut number 626, the cut contents 627, the material ID 628, the start time 629, and the special effects information 633 correspond to a cut number 517, cut contents 518, a material ID 519, start time 520, and an edit effect 521 of the program structure table. The In point 631, the Out point 632, and the special effects information 633 are given according to the editing operation of the image material performed in step 4. The program structure table metadata generated by the program structure editing device 130 is inputted to the program structure table registration unit 115. The program structure table registration unit 115 registers the program structure table metadata into the database unit 112. The program structure table registration unit 115 inputs the program structure table metadata to the simplified program replay metadata generation start unit 113.

In this embodiment, to describe the program structure to be easily understood, image materials are arranged according to the program structure, the operation deciding the In point and the Out point is performed using the program structure editing device 130, and the program structure table metadata is generated as the result. Without using the program structure editing device 130, the nonlinear editing device 140 can directly cut and paste the image material or replace the materials, and decide the In point and the Out point of the materials. In this case, the program structure metadata does not always have the data structure of FIG. 7 and has the data structure of the edit metadata.

In step 4, the nonlinear editing device 140 or the telop editing device 150 performs the editing operation of the image material. Step 4 is divided into step 4-1 performing editing such as cut and combination of the image materials stored in the database unit 112 using the nonlinear editing device 140 and step 4-2 providing special effects such as a telop and editing effect to the image material edited using the telop editing device 150. The edited image material edited in step 4 is an image actually used for the program and is called a complete package. The complete package is held in a database (not shown) other than the database unit 112. The nonlinear editing device 140 or the telop editing device 150 edits the image material and generates the edit metadata describing the edited contents. In this embodiment, EDL (Edit Decision List) metadata is generated.

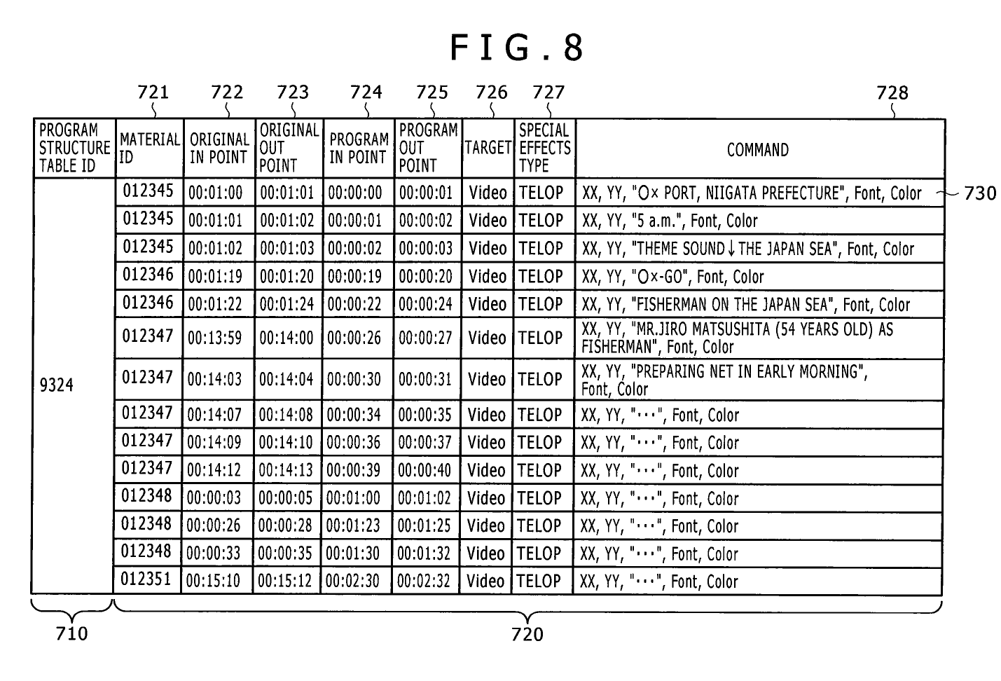

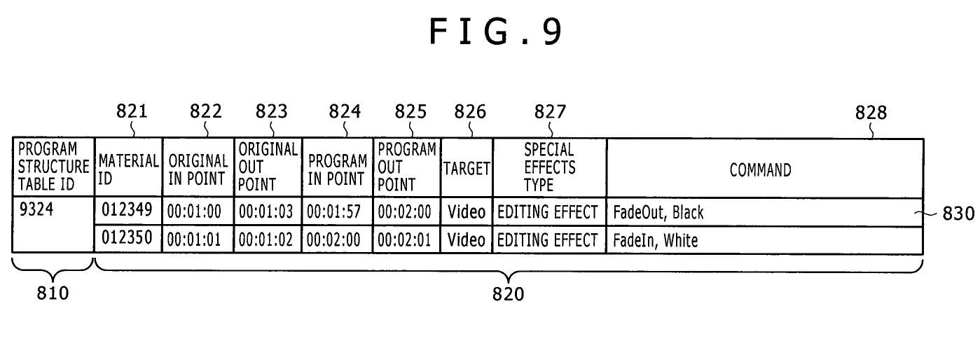

The edit metadata generated by the nonlinear editing device 140 or the telop editing device 150 will be described. As shown in FIGS. 8 and 9, the edit metadata is outputted by the editing devices, is not in a standardized format, and has a data structure specific to the editing device maker. The edit metadata shown in FIG. 8 is generated and outputted by the telop editing device 150. As indicated by the reference numeral 710, the edit metadata has the loop of a program structure table ID 710 and various edit items 720. The edit items are an image material ID 721, an original In point 722 and an original Out point 723 describing the actually used place in the original image material, a program In point 724 and a program Out point 725 showing a place incorporated into the program, a target 726 showing whether the edited type is a video, audio, or both, a special effects type 727 showing which special effects are provided between the In point and the Out point, and a special effects command 728 of the editing device. For instance, the reference numeral 730 indicates that special effects are provided to the image portion between time count “00:01:00 to 00:01:01” of the image material of the image materials with the image material ID=012345 and the program uses “00:00:00 to 00:00:01”. The special effects show that a “telop” is provided and issues the command “XX, YY, “o× Port, Niigata Prefecture”, Font, Color”. The character string “o× Port, Niigata Prefecture” is added to the image on the XX axis and the YY axis by specifying Font and the color of the characters. The edit metadata shown in FIG. 9 is generated and outputted by the nonlinear editing device 140. As indicated by the reference numeral 810, as in the edit metadata shown in FIG. 8, the edit metadata has the loop of the program structure table ID 810 and various edit items 820. The reference numeral 830 indicates that special effects are provided to the image portion of time count “00:01:00 to 00:01:03” of the image material of the image materials with the image material ID=012349 and the program uses “00:01:57 to 00:02:00”. The special effects show that an “edit effect” is provided and issues the “FadeOut, Black” command. This shows that the editing effect fading out the screen to black is provided. The edit metadata generated by the nonlinear editing device 140 or the telop editing device 150 is inputted to the edited data registration unit 116. The edited data registration unit 116 registers the edit metadata into the database unit 112 and inputs it to the simplified program replay metadata generation start unit 113.

The image material metadata, the program structure table metadata, or the edit metadata is inputted to the simplified program replay metadata generation start unit 113. The simplified program replay metadata generation start unit 113 receives notification of registration completion of various metadata to perform start judgment of the simplified program replay metadata generation unit 111. Here, start judgment of the simplified program replay metadata generation start unit 113 will be described. For instance, the simplified program replay metadata generation start unit 113 judges generation start at timing immediately before step 3 in program production is ended, that is, when there is new registration or update registration of the program structure table metadata from the program structure table registration unit 115. This case responds to the request to successively view the material in the structure table by the simplified structure when the program is not completed. The simplified program replay metadata generation start unit 113 judges generation start at timing immediately before steps 4-1 and 4-2 in program production are ended, that is, when there is new registration or update registration of the edit metadata from the image editing devices. This case responds to the request to simply check the program editing effect together with the image from a terminal other than the image editing devices. The simplified program replay metadata generation start unit 113 judges generation start when there is new registration or update registration of the image material metadata from the image material registration unit 114. This case responds to the request when there is new registration or update registration of the image material after the program structure table is registered. The simplified program replay metadata generation start unit 113 judges generation start when the program structure table ID is registered. The simplified program replay metadata generation start unit 113 has an interface with the program structure editing device 130 and specifies the program structure table ID from the program structure editing device 130 to receive program production completion instruction or complete package transfer request. From this request, the simplified program replay metadata generation start unit 130 judges that the complete package is created and transmits the simplified program replay metadata generation request to a program having the program structure table ID to the simplified program replay metadata generation unit 113. The simplified program replay metadata generation start unit 113 receives notification of registration completion of various metadata or registration of the program structure table ID to perform start judgment, and transmits the simplified program replay metadata generation request to the simplified program replay metadata generation unit 111 together with the program structure table ID. The simplified program replay metadata generation unit 111 executes the generation process of the simplified program replay metadata.

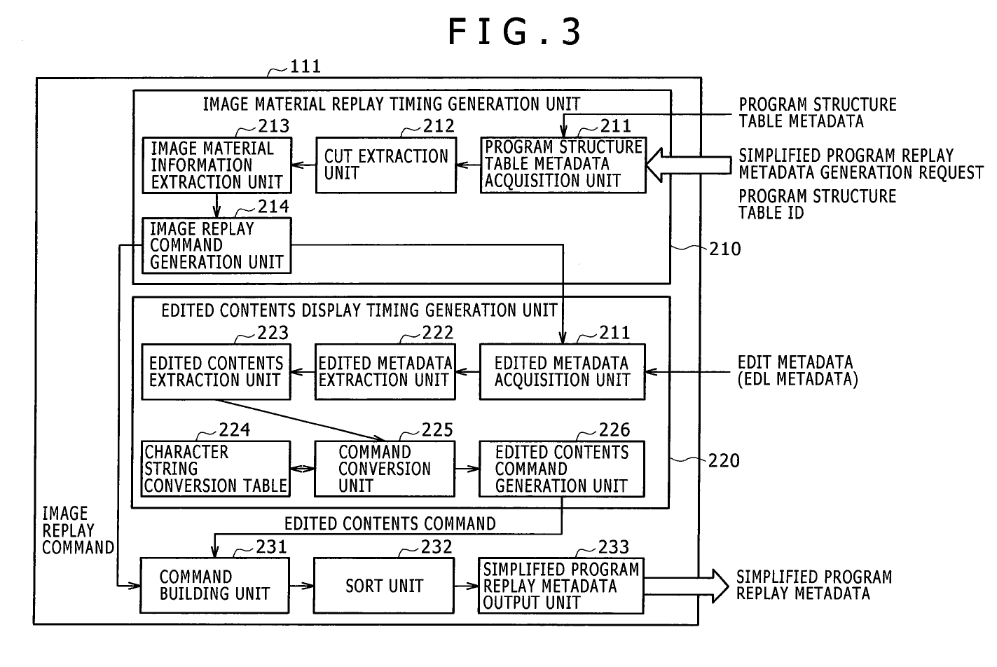

The internal configuration of the simplified program replay metadata generation unit 111 will be described. As shown in FIG. 3, the simplified program replay metadata generation unit 111 has an image material replay timing generation unit 210 describing replay timing of the image material, an edited contents display timing generation unit 220 describing display timing of the edited contents, a command building unit 231 building an image replay command generated by the image material replay timing generation unit 210 and an edited contents command generated by the edited contents display timing generation unit 220, a sort unit 232 chronologically sorting the image replay command and the edited contents command built by the command building unit 231, and a simplified program replay metadata output unit 233 outputting the simplified program replay metadata having the sorted image replay command and edited contents command. The image material replay timing generation unit 210 has a program structure table metadata acquisition unit 211 acquiring a program structure table ID and program structure table metadata associated therewith, a cut extraction unit 212 extracting one cut from the cut loop of the program structure table metadata, an image material information extraction unit 213 extracting information on the image material from the extracted one cut, and an image replay command generation unit 214 generating the image replay command according to the information extracted by the image material information extraction unit 213. The edited contents display timing generation unit 220 has an edit metadata acquisition unit 221 acquiring edit metadata associated with the program structure table ID, an edit metadata extraction unit 222 extracting edit metadata for each item, an edited contents extraction unit 223 extracting the edited contents from the edit metadata of the extracted one item, a command conversion unit 225 converting a command included in the extracted edited contents to a character string, and an edited contents command generation unit 226 generating the edited contents command generating the edited contents command according to the extracted edited contents and the converted character string. The edited contents display timing generation unit 220 has a character string conversion table 224 associating the command with the character string describing the command. The command conversion unit 225 uses the character string conversion table 224 to convert the command to the character string. The character string conversion table 224 will be described later.

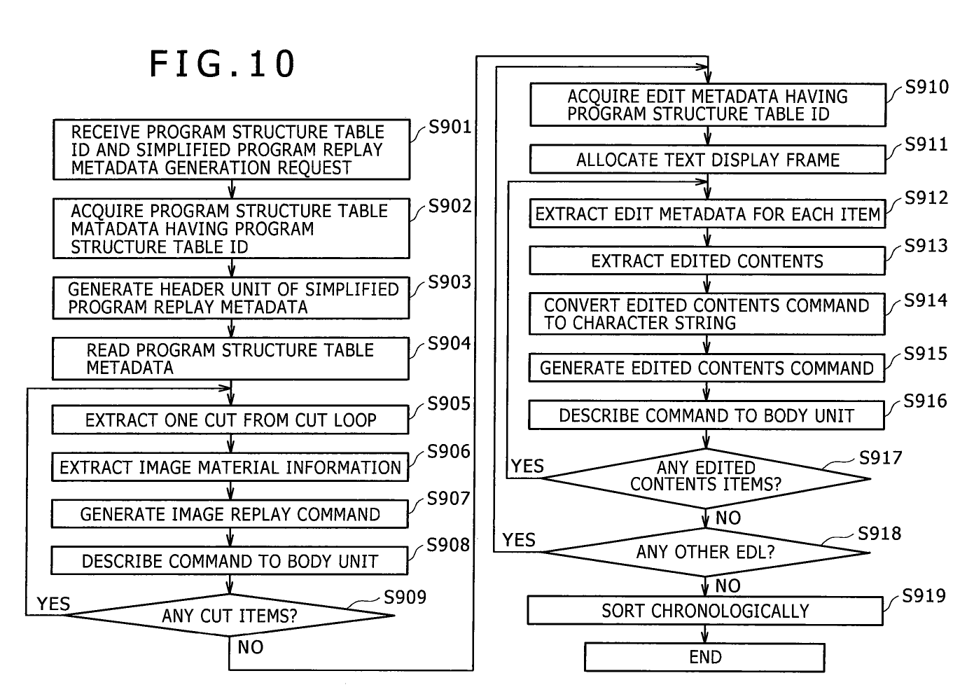

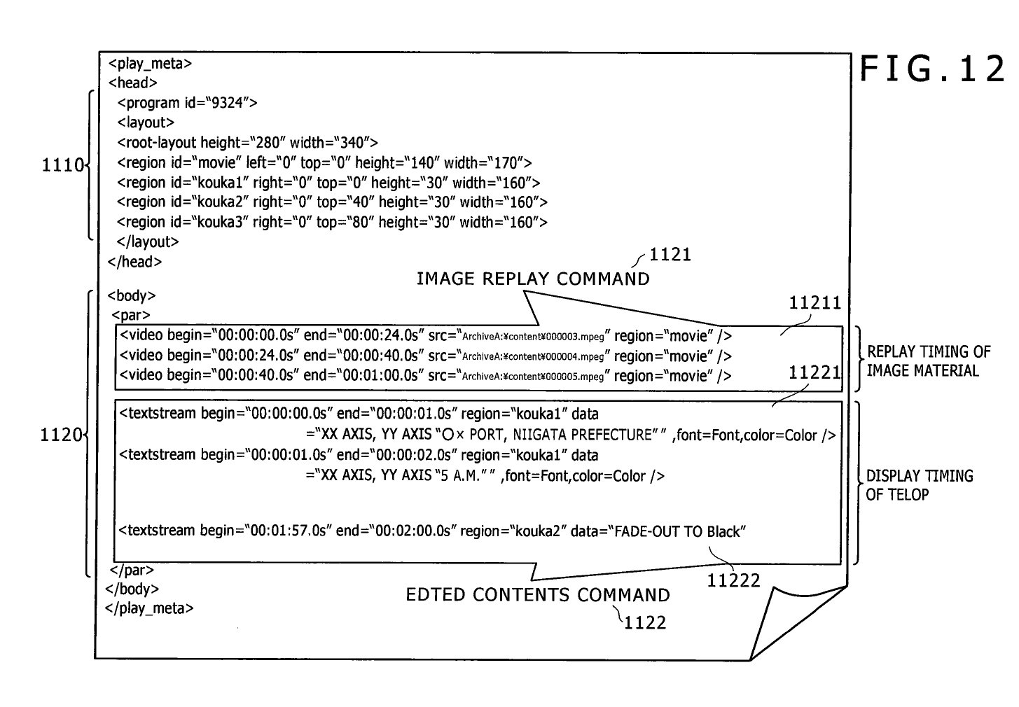

The operation of the generation process of the simplified program replay metadata will be described using FIG. 10. As described above, the simplified program replay metadata generation start unit 113 receives notification of registration completion of various metadata or registration of the program structure table ID to perform start judgment, and transmits the simplified program replay metadata generation request to the simplified program replay metadata generation unit 111 together with the program structure table ID. The simplified program replay metadata generation unit 111 receives the program structure table ID and the simplified program replay metadata generation request and executes the generation process of the simplified program replay metadata (S901). The program structure table ID and the simplified program replay metadata generation request are transmitted to the program structure table metadata acquisition unit 211. The program structure table metadata acquisition unit 211 acquires the program structure table metadata having the program structure table ID (S902). The acquired program structure table ID or the program structure table metadata is used to generate the header unit of the simplified program replay metadata (S903). The header unit gives the program structure table ID to decide the layout of the simplified program replay screen. For instance, a header unit 1110 of the simplified program replay metadata shown in FIG. 12 gives <program id=1193241> to the program structure table ID. The layout shows use of four types of <region id=>. In this embodiment, <region id=“movie”> is used as the frame for image material replay and in the remaining three types, <region id=“kouka”> is used as the frame for edited contents display. The number of frames may be changed according to the number of edit metadata, that is, the number of editing effects.

The body unit of the simplified program replay metadata is generated. A body unit 1120 generates an image replay command 1121 describing image material replay timing and an edited contents command 1122 describing edited contents display timing. The image replay command 1121 is generated by reading the program structure table metadata acquired by the program structure table metadata acquisition unit 211 to transmit it to the cut extraction unit 212 (S904). The cut extraction unit 212 extracts information on the portion corresponding to one cut from the cut loop of the program structure table metadata (S905). For instance, according to the program structure table metadata of FIG. 7, the portions of the reference numerals 626 to 633 are extracted. The cut extraction unit 212 transmits information on the extracted one cut to the image material information extraction unit 213. The image material information extraction unit 213 extracts image material information from the information on one cut (S906). The image material information includes the material ID 628, the In point 631, and the Out point 632. The image material information extraction unit 213 transmits the extracted image material information to the image replay command generation unit 214. The image replay command generation unit 214 acquires the image material metadata associated with the image material information and the location described in the image material metadata to generate the image replay command (S907). For instance, when the material ID 628 is transmitted as the image material information, the image material metadata associated with the material ID 628 can be acquired. The image material held in the database unit 112 can be acquired by the location 402 described in the image material metadata. An image replay command 11211 to one cut generated by the image replay command generation unit 214 is described as one of commands to the image replay command 1121 of the body unit 1120 of the simplified program replay metadata (S908). The image replay command is described to the simplified program replay metadata by transmitting the image replay command generated by the image replay command generation unit 214 to the command building unit 231. This ends generation of the image replay command to one cut of the program structure table metadata. When there is the next cut item in the cut loop in the sequence or the scene, steps 905 to 908 are performed until there is no cut items (S909). When there is no cut items, the edited contents command 1122 of the body unit of the simplified program replay metadata is generated. For generation of the edited contents command, the image replay command generation unit 214 transmits the program structure table ID to the edit metadata acquisition unit 221 of the edit contents display timing generation unit 220.

In this embodiment, generation of the image replay command of the material uses the program structure table metadata generated by the program structure editing device 130. The edit metadata as the result obtained by performing cut link of the material structuring the program by the nonlinear editing device may be used. In this case, the edit metadata has the image material information 830 for each cut as in the edit metadata shown in FIG. 9 and has a data structure into which data of a special effects type 827 and a command 828 are not registered.

The edit metadata acquisition unit 221 acquires edit metadata having the program structure table ID (S910). The display frame for text displaying the described contents of the acquired edit metadata is decided (S911). One display frame described in the header unit generated in step 903 is allocated. For instance, the header unit 1110 of the simplified program replay metadata shown in FIG. 12 has three types of <region id=“kouka”> as the frame for edited contents display. To text display one kind of edit metadata, one display frame is allocated. The display frame may be allocated in the process order of the edit metadata. Alternatively, the display frame may be associated according to the special process type in the edit metadata.

The edited contents command 1122 is generated by reading the edit metadata acquired by the edit metadata acquisition unit 221 to extract the edit metadata for each item by the edit metadata extraction unit 222 (S912). For instance, according to the edit metadata of FIG. 8, the portion of the reference numeral 730 is extracted. The edit metadata extraction unit 222 transmits the edit metadata of the extracted one item to the edited contents extraction unit 223. The edited contents extraction unit 223 extracts the edited contents from the edit metadata of one item (S913). According to the edit metadata of FIG. 8, the program In point 724, the program Out point 725, the special effects type 727, and the command information 728 are extracted. The extracted edited contents are transmitted to the command conversion unit 225. The command conversion unit 225 uses the character string conversion table 224 to convert the command information 728 to a character string (S914).

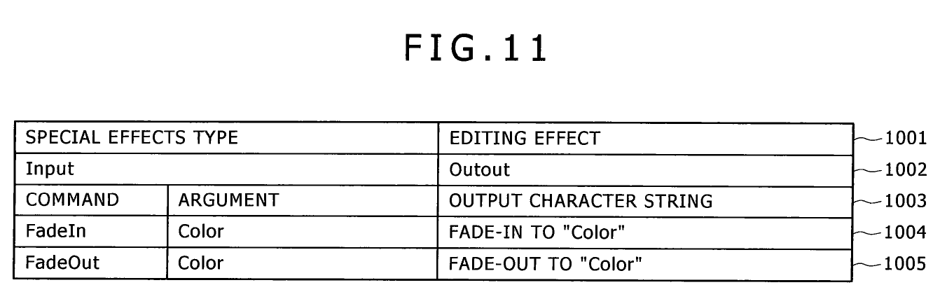

The character string conversion table will be described. As shown in FIG. 11, the character string conversion table is a table associating a command with a character string describing the command. The reference numeral 1001 defines character string conversion when special effects type=“editing effect” and the reference numeral 1002 defines character string conversion of a command in the edit metadata. The reference numeral 1103 associates a command, an argument, and an output character string with each other. The reference numeral 1104 indicates that command=“FadeIn” and argument=“Color” are character string converted to output character string=“fade-out to “Color”” and outputted. The reference numeral 1105 indicates that command=“FadeOut” and argument=“Color” are character string converted to output character string=“fade-out to “Color”” and outputted. For instance, when edit metadata shown in FIG. 9 is acquired to extract the portion of the reference numeral 830, the extracted edited contents are a program In point 824=“00:01:57”, a program Out point 825=“00:02:00”, the special effects type 827=“editing effect”, and the command information 828=“FadeOut, Black”. When the edited contents are inputted to the command conversion unit 225, the command conversion unit 225 uses the character string table 224 to convert the edited contents to the command information 828=“fade-out to Black”. In this embodiment, conversion of the command information to a character string is done only when the special effects type is the editing effect. When the special effects type is a telop effect, the command information is not character string converted and the command is used as it is.

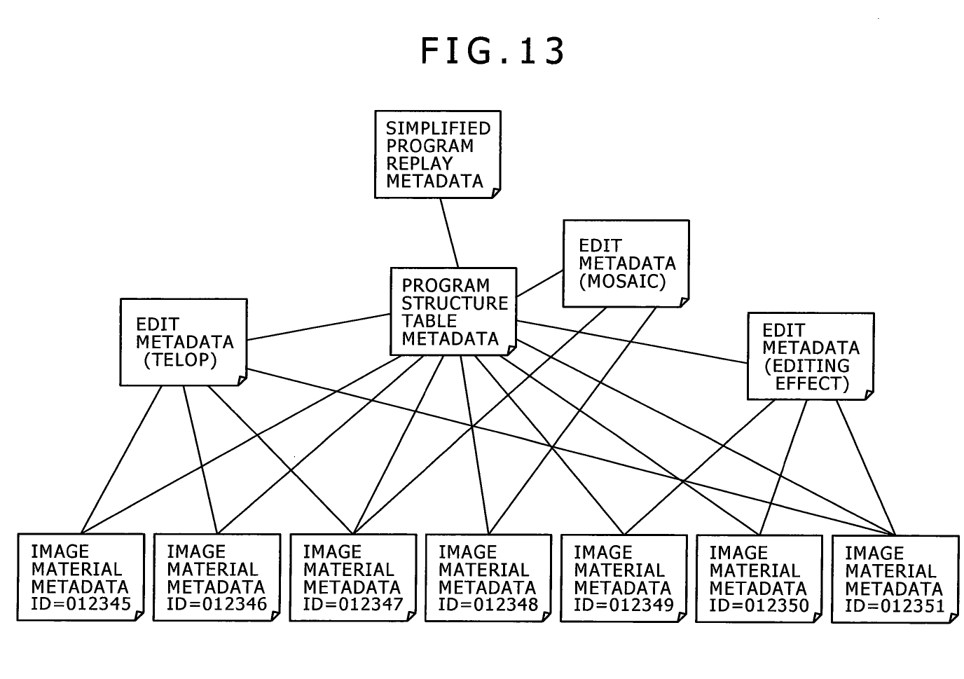

The character string converted using the character string conversion table 224 or the command is used to generate the edited contents command (S915). For instance, when the reference numeral 730 of the edit metadata shown in FIG. 8 is extracted, <textstream begin=“00:00:00. 0s” end=“00:00:01. 0s” region=“kouka1” data=“XX axis, YY axis “o× Port, Niigata Prefecture””, font=Font, color=Color/> is generated as the edited contents command. When the reference numeral 830 of the edit metadata shown in FIG. 9 is extracted, <textstream begin=“00:01:57. 0s” end=“00:02:00. 0s” region=“kouka2” data=“fade-out to Black”/> is generated as the edited contents command. An edited contents command 11221 generated by the edited contents command generation unit 226 is described as one of commands to the edited contents command 1122 of the body unit 1120 of the simplified program replay metadata (S916). For instance, the reference numerals 11221 and 11222 are described to an edited contents command 1222 of a body unit 1220 of the simplified program replay metadata shown in FIG. 12. The edited contents command is described to the simplified program replay metadata by transmitting the edited contents command generated by the edited contents command generation unit 226 to the command building unit 231. This ends generation of the edited contents command to one item of the edit metadata. When the extracted edit metadata has the next item, steps 912 to 916 are performed until there are no items (S917). When there are other types of edit metadata, steps 910 to 917 are performed until there are no edit metadata (S918). By performing the above processes, the image replay command and the edited contents command are generated to be transmitted to the command building unit 231. The command building unit 231 builds the respective commands to transmit them to the sort unit 232. The sort unit 232 chronologically sorts the respective built commands so that the simplified program can be replayed chronologically (S919). The respective commands are sorted to end generation of the simplified program replay metadata. The simplified program replay metadata is transmitted to the simplified program replay metadata output unit 233. The simplified program replay metadata output unit 233 transmits the generated simplified program replay metadata to the database unit 112. The database unit 112 holds the simplified program replay metadata associated with various metadata. As shown in FIG. 13, the database unit 112 manages the image material metadata, the program structure table metadata, the edit metadata, and the simplified program replay metadata associated with each other. The program structure table metadata and the image material metadata are associated by the image material ID. The program structure table metadata and the edit metadata are associated by the special effects. The program structure table metadata and the simplified program replay metadata are associated by the program structure table ID. The program structure table metadata can manage the image material metadata, the edit metadata, and the simplified program replay metadata associated with each other.

This embodiment can use the image material metadata, the simplified program table metadata, and the edit metadata registered into the archive management device to generate the simplified program replay metadata having the image replay command and the edited contents command and store these metadata item associated with each other in the database. In the operation described in this embodiment, the computer in the archive management device executes the archive management program recorded onto the recording medium (not shown) in the archive management device to perform the process.

### Embodiment 2

As described in Embodiment 1, the database unit 112 holds the image material metadata, the program structure table metadata, the edit metadata, and the simplified program replay metadata associated with each other. In this embodiment, search for the image material stored in the archive management device using the image material search referring device and replay of the simplified program from the result will be described.

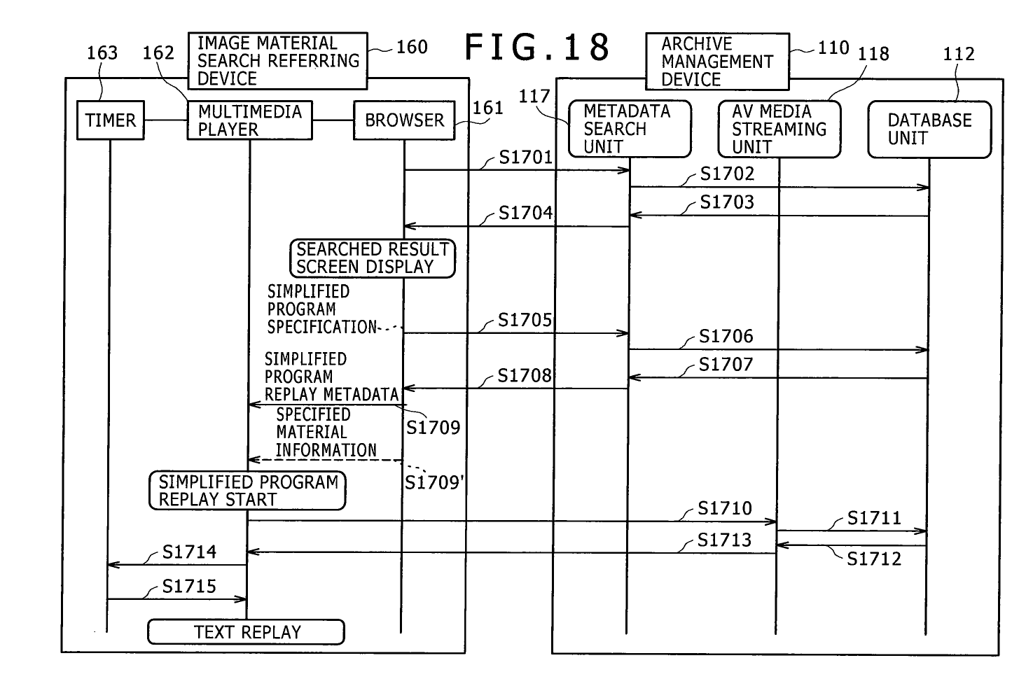

The image material search referring device 160 will be described. As shown in FIG. 18, the image material search referring device 160 has a browser unit 161 requesting search for the image material to the archive management device 110 and requesting the simplified program replay metadata according to the result of image material search, a multimedia player unit 162 requesting simplified program replay according to the simplified program replay metadata received by the browser unit 161 to replay the simplified program, and a timer unit 163 counting replay time of the simplified program.

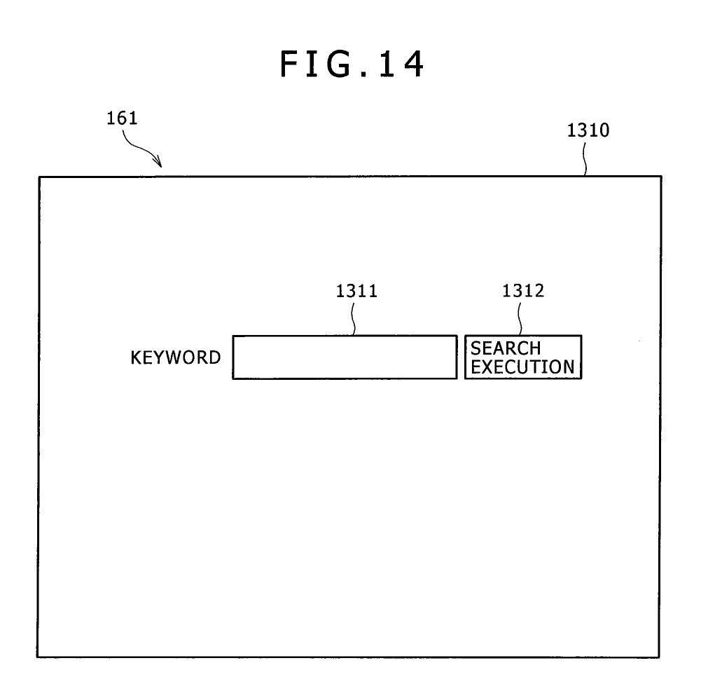

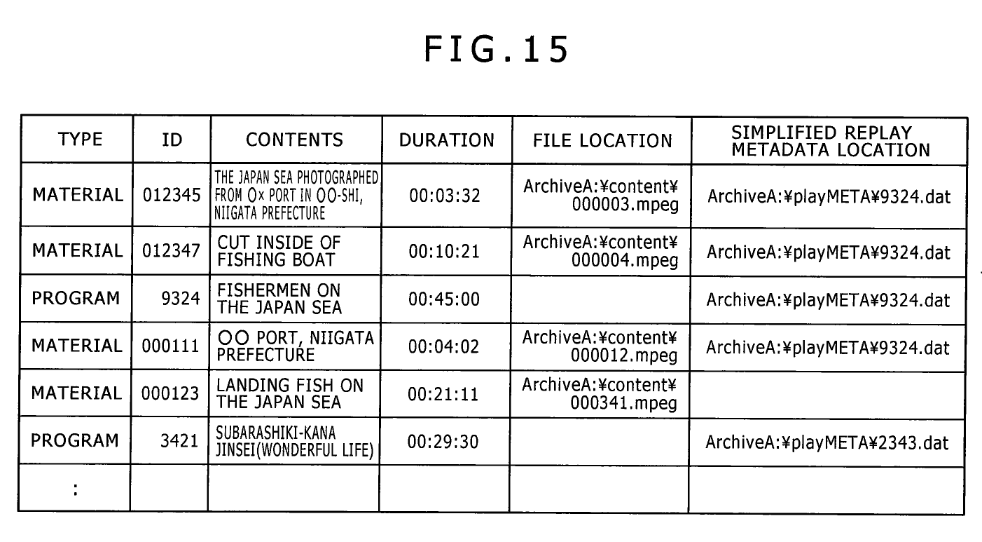

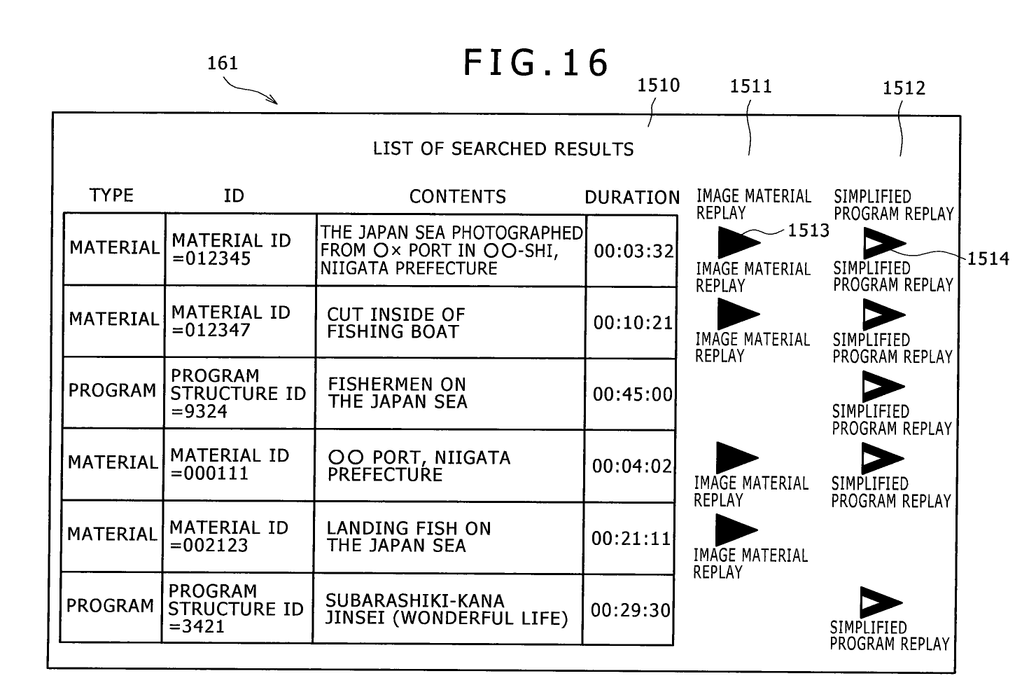

The operation performing the search process of the image material using the image material search referring device 160 will be described below. The browser unit 161 of the image material search referring device 160 displays search GUI (Graphical User Interface) and uses the search GUI to output the search request of the image material to a metadata search unit 117 of the archive management device 110 (S1701). As shown in FIG. 14, search GUI 1310 before the image material is searched displays a box 1311 inputting a keyword and a search execution button 1312. The user inputs a keyword into the box 1311 via the input means such as a keyboard or a mouse to press the search execution button 1312. The inputted keyword as a search key outputs the search request of the image material. The metadata search unit 117 which has received the image material search request searches for the image material metadata or the program structure table metadata including the search keyword from the database unit 112 (S1702). The searched item is considered the character string portion of various metadata. For instance, the program structure table metadata is searched from a program title 613, a comment 615, sequence information 621, scene information 625 and cut contents 627. The image material metadata is searched from the photographer 403, the title 405, description of material 407, the photographed object 408, and the photographing place 409. The database unit 112 generates the corresponding image material metadata or program structure table metadata as a list of searched results (see FIG. 15) and transmits it to the metadata search unit 117 (S1703). The metadata search unit 117 transmits the list of searched results transmitted from the database unit 112 to the browser unit 161 (S1704). As shown in FIG. 16, the browser unit 161 has a display unit 1510 converting the image material searched result to GUI. The display unit 1510 has an image material replay request button 1511 requesting replay of the image material from the displayed image material searched result and a simplified program replay request button 1512 requesting replay of the simplified program. The user presses the image material replay request button 1511 via the input means such as a keyboard or mouse to request the streaming of the image material to the AV media streaming unit 118 of the archive management device 110. When an image material replay request button 1513 is pressed, the streaming of the image material with the material ID=“012345” is requested. The AV media streaming unit 118 acquires the image material stored in the database unit 112 and transmits it to the browser unit 161. The browser unit 161 transfers the acquired image material to the multimedia player 162. The multimedia player 162 can replay the image material. The user presses the simplified program replay request button 1512 via the input means such as a keyboard or mouse to request the simplified program replay metadata to the metadata search unit 117 of the archive management device 110 (S1705). When a simplified program replay request button 1514 is pressed, the simplified program replay metadata using the material ID=“012345” is requested. The metadata search unit 117 searches for, from the database unit 112, the program structure table metadata using the image material ID corresponding to the position in which the simplified program replay request button 1512 is pressed and searches for the simplified program replay metadata using the program structure table ID from the database unit 112 (S1706). The database unit 112 transmits the corresponding simplified program replay metadata to the metadata search unit 117 (S1707). The metadata search unit 117 acquires the simplified program replay metadata to transmit it to the browser unit 161 (S1708). The browser unit 161 transfers the simplified program replay metadata to the multimedia player unit 162 (S1709). The multimedia player unit 162 requests the streaming of the image material described in the simplified program replay metadata to the AV media streaming unit 162 (S1710). The AV media streaming unit 118 acquires the image material stored in the database unit 112 according to the streaming of the image material (S1711, S1712). The AV media streaming unit 118 transfers the acquired image material to the multimedia player unit 162 (S1713). The multimedia player unit 162 requests the timer unit 163 to set count 0 (zero) (S1714) and receives the response (S1715). The multimedia player unit 162 uses the acquired image material and simplified program replay metadata to replay the simplified program.

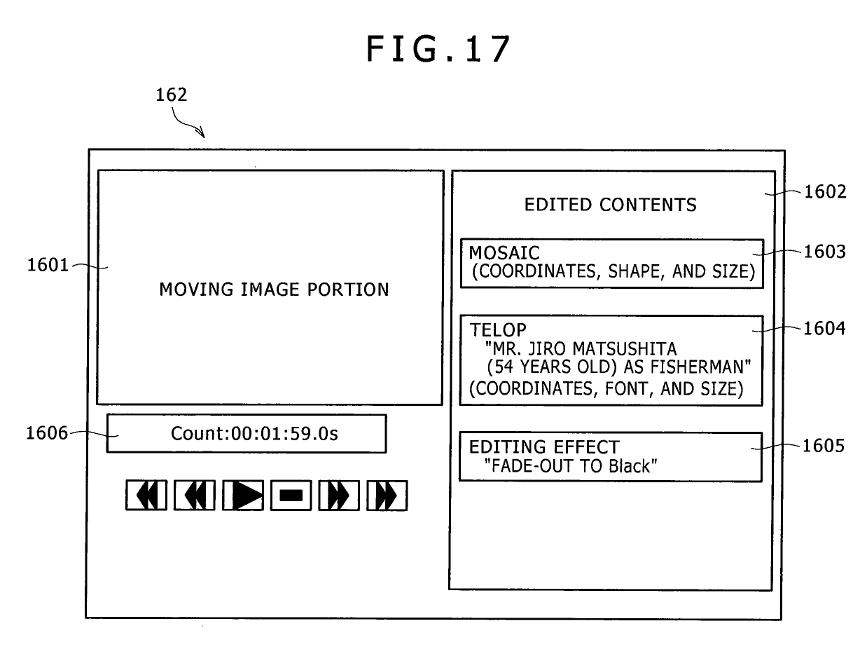

The simplified program replayed by the multimedia player unit 162 will be described. As shown in FIG. 17, the multimedia player unit 162 has a moving image replay frame 1601 replaying the image of the simplified program according to the image replay command of the simplified program replay metadata and a text display frame 1602 displaying the edited contents of the simplified program according to the edited contents command of the simplified program replay metadata. The multimedia player unit 162 acquires count information of the timer unit 163 and changes with time the image of the simplified program replayed by the moving image replay frame 1601 and the edited contents of the simplified program displayed in the text display frame 1602 according to the count information. The text display frame 1602 has a mosaic effect display frame 1603 displaying a mosaic effect, a telop effect display frame 1604 displaying a telop effect, and an editing effect display frame 1605 displaying an editing effect described in the simplified program replay metadata and is changed with time according to the edited contents command. In this embodiment, the multimedia player unit 162 has a counter 1606 displaying count information acquired from the timer unit 163 and can easily grasp replay timing of the image material and display timing of the edited contents.

In step 1709, when the simplified program replay metadata is transferred to the multimedia player unit 162, the image material information corresponding to the position in which the simplified program replay request button 1512 is pressed may be acquired and the acquired image material information may be transferred to the multimedia player unit 162 together with the simplified program replay metadata (S1809′). The multimedia player unit 162 may acquire the image material information transferred from the browser unit 161 together with the simplified program replay metadata and use the image material information to request and replay the image material from the image replay command corresponding to the simplified program replay metadata or the image replay command immediately therebefore. In FIG. 16, when the user is interested in the image material ID=012345 from the image material search resulted displayed on the browser unit 161 and presses the program replay button 1514 of the image material, the information on the image material is transferred to the multimedia player unit 162. The image replay command of the simplified program replay metadata performs streaming in the position in which the image material is used or therebefore. When there is the image material or program in which the user is interested from the image material searched result, the simplified program can be replayed from the position in which the button is pressed. The user can quickly recognize application of the image material in the program.

In this embodiment, the image material search referring device is used to search for the image material stored in the archive management device to be linked to the simplified program replay metadata from the result and can replay the simplified program corresponding to the complete package. Application of the used image material can be checked without accessing the database device storing the complete package. In the operation described in this embodiment, the computers in the archive management device and the image material search referring device execute the programs recorded onto the recording media (not shown) of the devices to perform the process.

The archive management device according to the present invention is applicable to a program production system managing a program image material.

The present invention is described above based on the preferred embodiments shown in the drawings. It is apparent that those skilled in the art can easily change and modify the invention and such changed portions are included in the scope of the invention.

What is claimed is:

1. An archive management device, comprising:
a database unit that holds an image material and image material metadata describing contents of the image material, program structure table metadata that describes a cut point and sequence of a material structuring a program, and edit metadata that describes the edited contents having an edit section and a special effects command of the image material; and
a simplified program replay metadata generation unit that executes, to a program structure table ID uniquely specifying the inputted program structure table, a generation process of simplified program replay metadata based on the image material metadata, the program structure table metadata, and the edit metadata held in the database unit and associated with the program structure table ID.

2. The archive management device according to claim 1,
wherein the simplified program replay metadata generation unit has an image material replay timing generation unit describing image material replay timing,
the image material replay timing generation unit including:
a program structure table metadata acquisition unit that acquires a program structure table ID uniquely specifying the program structure table and program structure table metadata associated with the program structure table ID;
a cut extraction unit that extracts one cut from a cut loop of the program structure table metadata;
an image material information extraction unit that extracts image material information from the extracted one cut; and
an image replay command generation unit that generates an image replay command according to the information extracted by the image material information extraction unit.

3. The archive management device according to claim 1,
wherein the simplified program replay metadata generation unit has an edited contents display timing generation unit that describes edited contents display timing,
the edited contents display timing generation unit including:
an edit metadata acquisition unit that acquires edit metadata associated with the program structure table ID;
an edit metadata extraction unit that extracts the edit metadata for each item;
an edited contents extraction unit that extracts edited contents from the edit metadata of the extracted one item;
a command conversion unit that converts a special effects command included in the extracted edited contents to character string information; and
an edited contents command generation unit that generates an edited contents display command for displaying the converted character string information in the same period as the edit section of the edited contents.

4. The archive management device according to claim 3, wherein the simplified program replay metadata generation unit has a character string conversion table associating the special effects command with a character string describing the special effects command, and the command conversion unit uses the character string conversion table to character string convert the special effects command.

5. The archive management device according to claim 3,
wherein the simplified program replay metadata generation unit includes:
a command building unit that builds the image replay command generated by the image material replay timing generation unit and the edited contents display command generated by the edited contents display timing generation unit;
a sort unit that chronologically sorts the image replay command and the edited contents display command built by the command building unit; and
a simplified program replay metadata output unit that outputs simplified program replay metadata having the sorted image replay command and edited contents display command.

6. The archive management device according to claim 1, wherein the simplified program replay metadata generation unit registers the generated simplified program replay metadata into the database unit.

7. The archive management device according to claim 1, further comprising a simplified program replay metadata generation start unit that receives notification of registration completion of the image material metadata, notification of registration completion of the program structure table metadata, or notification of registration completion of the edit metadata to control the simplified program replay metadata generation unit, thereby controlling generation timing of the simplified program replay metadata.

8. The archive management device according to claim 1, wherein the archive management device has an AV media streaming unit that transmits streaming of the corresponding simplified program upon reception of a simplified program replay request.

9. The archive management device according to claim 1, wherein the edit metadata is EDL metadata.

10. The archive management device according to claim 1, wherein the program structure table metadata is EDL metadata.

11. An archive management system, comprising:
the archive management device according to claim 1; and
an image material search referring device including:
a browser unit requesting image material search to the archive management device and requests simplified program replay metadata according to a result of the image material search;
a multimedia player unit that requests simplified program replay according to the simplified program replay metadata received by the browser unit and replays a simplified program; and
a timer unit that counts replay time of the simplified program.

12. The archive management system according to claim 11,
wherein the browser unit has a display unit that converts the result of the image material search to GUI,
the display unit displaying, only for an image material in which simplified program replay metadata is registered, an image material replay request button that requests replay of the image material and a simplified program replay request button that requests replay of the simplified program from the displayed image material searched result.

13. The archive management system according to claim 12, wherein the display unit requests simplified program replay metadata corresponding to a position in which the simplified program replay request button is pressed.

14. The archive management system according to claim 11, wherein the browser unit transfers the acquired simplified program replay metadata to the multimedia player unit.

15. The archive management system according to claim 11, wherein the browser unit acquires image material information corresponding to the position in which the simplified program replay request button is pressed and transfers the acquired image material information to the multimedia player unit together with the simplified program replay metadata.

16. The archive management system according to claim 11, wherein the multimedia player unit has a moving image replay frame that replays an image corresponding to the replay command according to the transferred simplified program replay metadata, and a character string display frame that displays character string information of the edited contents display command.

17. The archive management system according to claim 11, wherein the multimedia player unit acquires count information of the timer unit, and changes with time the image of the simplified program replayed in the moving image replay frame and the edited contents of the simplified program displayed in the text display frame according to the count information.

18. The archive management system according to claim 16, wherein the character string display frame has a mosaic effect display frame that displays a mosaic effect, a telop effect display frame that displays a telop effect, or an editing effect display frame that displays an editing effect described in the simplified program replay metadata.

19. The archive management system according to claim 11, wherein the multimedia player unit acquires the image material information transferred together with the simplified program replay metadata from the browser unit and uses the image material information to request and replay the simplified program from an image replay command of the simplified program replay metadata or an image replay command immediately therebefore.

20. An archive management program that allows a computer to function as:
a database unit that holds an image material and image material metadata describing contents of the image material, program structure table metadata that describes a cut point and sequence of a material structuring a program, and edit metadata that describes the edited contents of the image material; and
a simplified program replay metadata generation unit that executes, to a program structure table ID uniquely specifying the inputted program structure table, a generation process of simplified program replay metadata based on the image material metadata, the program structure table metadata, and the edit metadata held in the database unit and associated with the program structure table ID.
